(19) United States
(12) Patent Application Publication
(10) Pub. No.: US 2021/0242734 A1
(43) Pub. Date: Aug. 5, 2021

(54) ROTATIONALLY BALANCED ELECTRIC MOTOR WITH AIR-CORE STRATOR COILS

(71) Applicant: INTELLITECH PTY LTD, Malvern (AU)

(72) Inventors: Victor Shlakhetski, Ashqelon (IL); Alexander Mostovoy, Ashqelon (IL)

(73) Assignee: INTELLITECH PTY LTD, Malvern (AU)

(21) Appl. No.: 17/049,804

(22) PCT Filed: Apr. 26, 2019
(86) PCT No.: PCT/AU2019/050375

§ 371 Date: Oct. 22, 2020

(30) Foreign Application Priority Data
Apr. 27, 2018 (GB) 1806899.9

(51) Int. Cl. H02K 1/27; H02K 3/47; H02K 1/14; H02K 21/14; H02K 21/22; H02K 49/10; H02K 5/04; H02K 7/04; H02K 7/10; H02K 7/116; F16H 1/20

(52) U.S. Cl. CPC H02K 1/2753; H02K 3/47; H02K 1/14; H02K 21/145; H02K 21/22; F16H 2057/02034; H02K 5/04; H02K 7/04; H02K 7/1016; H02K 7/116; F16H 1/20; H02K 49/102

(57) ABSTRACT

A rotationally balanced electric motor with air-core stator coils having a casing; a magnet-equipped and externally geared annular rotor; an output shaft with a longitudinal axis positioned at a center of the rotor; a plurality of circumferentially spaced air-core stator coils connected to the casing and encircling the rotor; an externally geared disc parallel to the rotor and connected to, and concentric with, the output shaft; and a plurality of symmetrically positioned common-shaft gear pairs configured to transmit motion from the rotor to the disc and thereby transmitting power to the output shaft without interfering with any of the plurality of air-core stator coils.

### CROSS REFERENCE TO RELATED APPLICATIONS

This application claims priority to GB 1806899.9, filed Apr. 27, 2018, the entirety of which is incorporated herein by reference.

### TECHNICAL FIELD

The present invention relates to the field of electric motors.

### BACKGROUND

Electric motors typically include a stator and a rotor, and may be configured with air-core stator coils to transfer power with a relatively high power density while maintaining a compact design.

Notwithstanding certain benefits, electric motors that include air-core stator coils can suffer from various drawbacks and disadvantages. For example, such motors often transfer power from the rotor to a load by means of an output shaft. Prior art motors have utilized geared elements to transfer power to the output shaft to prevent interference with the air-core stator coils. However, such motors can suffer from rotational imbalance where a single geared element is mechanically connected to the output shaft, thereby requiring the load to be radially outside the rotation of the rotor. To avoid generating periodic linear and torsional forces perpendicular to the axis of rotation of the rotor, which can result in undesirable vibration, an electric motor should be rotationally balanced. Motor failure may result if the amplitude of such vibrations become excessive.

The present invention seeks to provide a rotationally balanced electric motor configured with air-core stator coils that may efficiently transfer power to the output shaft and load without interference with the stator coils. Other aspects and advantages of the invention will become apparent as the description proceeds.

The preceding discussion of the background art is intended to facilitate an understanding of the present invention only. The discussion is not an acknowledgement or admission that any of the material referred to is or was part of the common general knowledge as at the priority date of the application.

### SUMMARY

It is an object of this invention to provide a rotationally balanced electric motor which ameliorates, mitigates or overcomes, at least one disadvantage of the prior art, or which will at least provide the public with a practical choice.

A rotationally balanced electric motor is presented that may include a magnet-equipped annular rotor which rotates by interacting with a plurality of circumferentially spaced air-core stator coils that each encircle the rotor. Electromagnetic fields are induced when the stator coils are energized with electric current, and an induced electromagnetic field may interact with the magnetic field of each permanent magnet of the rotor to initiate rotation. The rotor may continue to rotate while the permanent magnets are introduced within the interior of each stator coil.

Some of the drawbacks of transferring power by prior art electric motors configured with air-core stator coils have been obviated by the disclosure herein by providing, for example, an externally geared disc connected to the output shaft which may be parallel to the annular and externally geared rotor. Each of a plurality of symmetrically positioned common-shaft gear pairs may serve to transmit motion from the rotor to the disc and to thereby transmit power to the output shaft, without interfering with the air-core stator coils and while maintaining rotational balance of the motor.

The present invention provides a rotationally balanced electric motor with air-core stator coils including a magnet-equipped and externally geared annular rotor; an output shaft with a longitudinal axis positioned at a center of the rotor; a plurality of circumferentially spaced air-core stator coils encircling the rotor; an externally geared disc parallel to the rotor and connected to, and concentric with, the output shaft; and a plurality of symmetrically positioned common-shaft gear pairs configured to transmit motion from the rotor to the disc and to thereby transmit power to the output shaft without interfering with any of said plurality of air-core stator coils.

In one aspect, the common shaft of each of the plurality of gear pairs may be rotatably mounted within two parallel surfaces of a casing. The casing may be hollow, and the rotor, the disc, the plurality of air-core stator coils, and the plurality of gear pairs may all be housed within an interior of the casing.

In one aspect, the motor may further include an annular bearing member for radially supporting the rotor, and a plurality of circumferentially spaced support posts extending for example in a direction parallel to the longitudinal axis of the output shaft and connected to an inner race of said bearing member. The bearing member may be a rotor-integrated bearing member which may be configured such that a plurality of rolling elements are retained between a rotor portion constituting an outer race of said rotor-integrated bearing member and an inner race portion, and that the rotor portion may be provided with external gearing that intermeshes with a first gear of the plurality of common-shaft gear pairs.

The present invention further provides a rotationally balanced electric motor with air-core stator coils, comprising:
a) a casing;
b) a magnet-equipped and externally geared annular rotor;
c) an output shaft with a longitudinal axis positioned at a center of said rotor;
d) a plurality of circumferentially spaced air-core stator coils connected to said casing and encircling said rotor;
e) an externally geared disc parallel to said rotor and connected to, and concentric with, said output shaft; and
f) a plurality of symmetrically positioned common-shaft gear pairs configured to transmit motion from said rotor to said disc and to thereby transmit power to said output shaft without interfering with any of said plurality of air-core stator coils.

### BRIEF DESCRIPTION OF THE DRAWINGS

Preferred embodiments of the present invention will now be described, by way of example only, with reference to the accompanying drawings, in which:

FIG. 1 is a perspective view of a motor according to one embodiment of the present disclosure, shown without certain features for clarity;

FIG. 2 is a perspective view of the motor of FIG. 1, showing certain additional mounting features;

FIG. 3 is a perspective view of the motor of FIG. 1, shown with the stator coils and the permanent magnets;

FIG. 4 is a cross-sectional view cut along plane A-A of FIG. 3, showing a rotor-integrated bearing member and permanent magnet when introduced within the air-core of a stator coil;

FIG. 5 is a perspective view of a housing and casing for enclosing, for example, the motor of FIGS. 1-4; and

FIG. 6 is a longitudinal cross-sectional view of a motor according to another embodiment of the present disclosure.

### DETAILED DESCRIPTION

While specific exemplary embodiments of the inventive subject matter now will be described with reference to the accompanying drawings, this inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it may be directly connected or coupled to the other element or intervening elements may be present. As used herein the term “and/or” includes any and all combinations of one or more of the associated listed items.

It should be initially understood that all the features disclosed herein may be combined in any combination, except combinations where at least some of such features and/or steps are mutually exclusive.

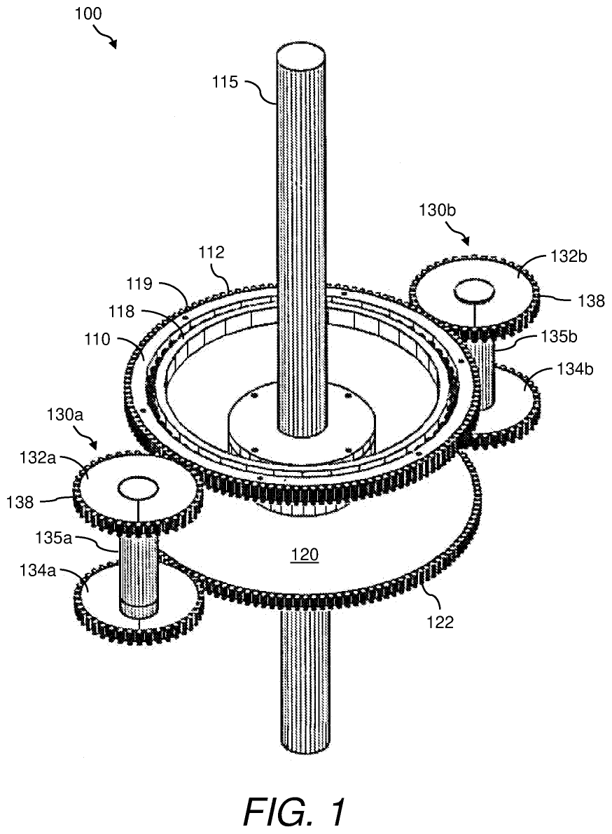

Referring now to FIG. 1, an exemplary embodiment of motor 100 according to various aspects of the present disclosure and with certain aspects removed from view for clarity is presented. According to some embodiments, the motor 100 may include an annular rotor 110 configured to rotate about and be concentric with an output shaft 115. An outer perimeter of annular rotor 110 may include external gearing 112. In some embodiments, annular rotor 110 may also include an annular bearing member 118 having an inner race of rolling elements 119 to facilitate a low-friction rotation of rotor 110. Any other suitable low-friction configuration may also be employed, including for example, lubricated low friction surfaces, magnetic levitation, etc.

Motor 100 may also include a power transfer disc 120 that is, in some embodiments, disposed substantially longitudinally to and parallel to annular rotor 110. The power transfer disc 120 may include external gearing 122 about its outer perimeter in a manner similar to the external gearing 112 on rotor 110. The power transfer disc 120 may also be coupled to output shaft 115 such that rotation of power transfer disc 120 causes rotation of output shaft 115.

In some embodiments, to facilitate power transfer from rotor 110 to power transfer disc 120, two or more gear pairs 130 may be utilized, for example, gear pair 130a and 130b illustrated in FIG. 1. Gear pairs 130 may include a first gear 132 (e.g., 132a & 132b) configured to interface with external gearing 112 of rotor 110, and a second gear 134 (e.g., 134a & 134b) configured to interface with external gearing 122 of power transfer disc 120. First gear 132 and second gear 134 may be fixedly mounted to a shaft 135 (e.g., 135a & 135b) such that rotation of first gear 132 causes like rotation of second gear 134. In some embodiments, the first and second gears 132, 134 may be spur pinions having external gearing 138 in the form of, for example, radial teeth disposed substantially parallel to output shaft 115 and the axis of rotation of rotor 110. External gearing 112 and 122 may be configured in like manner so as to efficiently intermesh with gearing 138 on gear pairs 130. Accordingly, in some embodiments, rotational energy from rotor 110 may be transmitted to first gear 132, thereby rotating shaft 135, which rotates second gear 134, which in turn causes rotation of power transfer disc 120 and ultimately rotation of output shaft 115.

Gear pairs 130 may be diametrically opposed from one another to ensure that motor 100 will be rotationally balanced to minimize generation of vibrations. While two such gear pairs 130 are illustrated, other numbers of gear pairs may be employed so long as all are symmetrically positioned to ensure that motor 100 remains substantially rotationally balanced.

In some embodiments, such as illustrated in FIG. 1, rotor 110 and power transfer disc 120 may be of substantially the same diameter, and first gear 132 and second gear 134 may be substantially the same diameter. It will be appreciated, however, that rotor 110 and power transfer disc 120 may be of different diameters, thereby necessitating different diameters of first gear 132 relative to second gear 134. In such embodiments, it may be advantageous to ensure that the gear ratio between the rotor 110 and the first gear 132 is equal to the gear ratio between the second gear 134 and power transfer disc 120 such that output shaft 115 will rotate at the same frequency as rotor 110. In certain other embodiments, it may be advantageous to adjust the gear ratios such that output shaft 115 is made to rotate at a frequency greater or less than rotor 110.

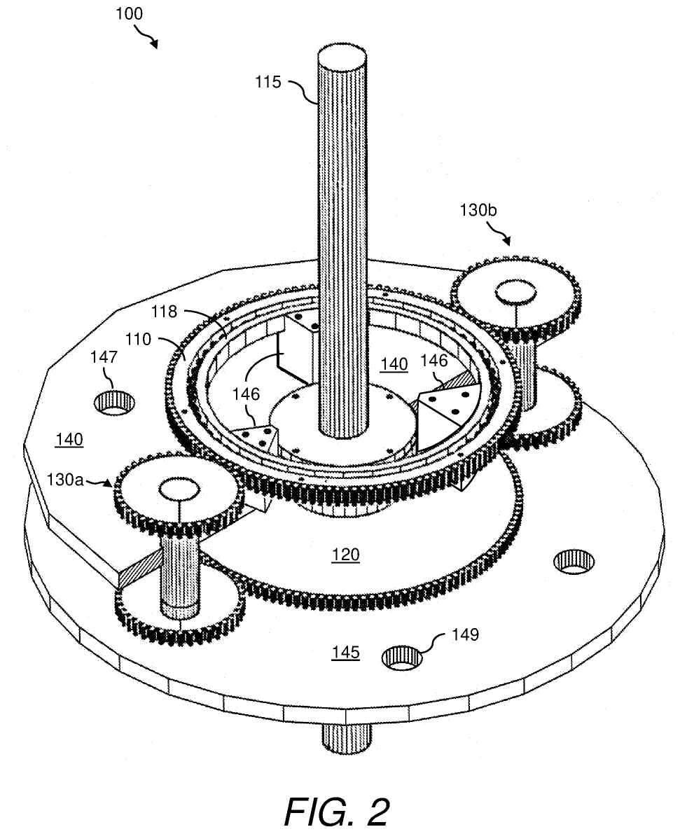

Referring now to FIG. 2, motor 100 may also include central plate 140, and end plate 145. Central plate 140 may, in some embodiments, be disposed parallel to and in between annular rotor 110 and power transfer disc 120, but other locations for central plate 140 are possible. In some embodiments, annular rotor 110 may be mounted to central plate 140, including in some embodiments via one or more support posts 146. For example, support posts 146 may be coupled to central plate 140 and to annular bearing member 118. Accordingly, rotor 110 may rotate by virtue of, for example, inner bearing race 119, relative to fixed central plate 140. Central plate 140 may also include two or more apertures 147 through which gear shafts 135 may pass and freely rotate therein. In some embodiments, central plate 140 includes a number of apertures 147 corresponding to the number of gear pairs 130 in motor 100, but in other embodiments, central plate 140 may have more apertures 147 than gear pairs 130 so as to, for example, save weight, accommodate additional gear pairs 130, and/or other benefits. In some embodiments, end plate 145 may have apertures 149, which may correspond to apertures 147.

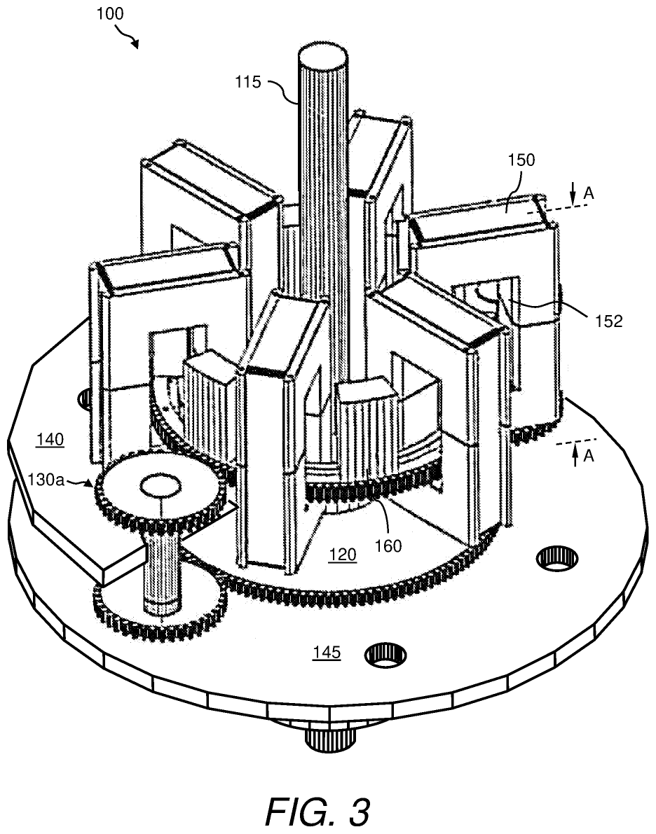

Referring now to FIG. 3, motor 100 is presented with additional elements of the motor presented according to some embodiments. In some embodiments, motor 100 may include one or more circumferentially spaced air-core stator coils 150 which may, in some embodiments, be coupled to central plate 140. Air-core stator coils 150 are so described because, in some embodiments, stator coils 150 may include a core 152 through which objects may pass. Motor 100 may also include one or more spaced permanent magnets 160 that may be coupled to rotor 110. Air-core stator coils 150 may be mounted such that rotor 110 with magnets 160 mounted thereon may rotate freely through each of the stators 150, for example, through core 152. In some embodiments, the support posts 146 (FIG. 2) may be sized and shaped to fit between, for example, adjacent air-core stator coils 150. For example, as illustrated in FIG. 2, support posts 146 may be substantially triangular so as to fit efficiently between, for example, adjacent radially mounted stators 150.

In FIG. 3, six air-core stator coils 150 are illustrated, although any other suitable number of stator coils may also be employed. In some embodiments, there may be the same number of permanent magnets 160 as air-core stator coils 150 to facilitate simultaneous introduction of all the magnets 160 into the core 152 of corresponding stator coils 150. In other embodiments, however, the number of permanent magnets 160 may be greater or less than the number of air-core stator coils 150.

The air-core stator coils 150 of motor 100 may be configured in various arrangements. In one embodiment, as shown for example in FIG. 3, the stator coils 150 may have a rectangular configuration with a rectangular air-core 152. Stator coil 150 is typically configured such that at least one or more turns of wire may be wound about core 152. In preferred embodiments, air core stator coil 150 may be sized such that the cross-sectional area of core 152 is minimized, while still being sufficiently large enough to allow rotor 110 (including annular bearing member 118) and magnets 160 to pass therethrough, but with minimal clearance so as to optimize energy transfer. Stator coil 150 may also include either a groove or hollow interior about core 152 for housing the one or more turns of wire therein.

The exemplary embodiment illustrated in FIG. 3 having a rectilinear configuration of stator coils 150 may advantageously facilitate the positioning of a common-shaft gear pair 130 between two adjacent air-core stator coils 150 to intermesh with the external gearing 112 of rotor 110. Additionally, the selected triangular configuration of the support posts 146 (shown in FIG. 2) may be adapted to accommodate the relatively small clearance that may result between the radially innermost portions of two adjacent air-core stator coils 150.

In certain embodiments, motor 100 may also include a system of switches (not shown). In one embodiment, the switches may be electrically connected to a DC supply and determine, at each instant, the polarity and the level of the voltage applied to each stator coil 150 via the corresponding wound conductive wire. The switches may be controlled by a component, preferably a microcontroller with associated software, capable of determining at each instant the DC polarity applied to each stator coil 150 (e.g., by inverting the DC connection to it), as well as the average DC level (e.g., by applying the DC supply voltage using Pulse Width Modulation (PWM)). The angular position of rotor 110 at each instant may be detected by a system of sensors (e.g., optical sensors or Hall-effect sensors). The sensor output may be fed to the controller, which may operate the switches according to the status of the rotor (i.e. angular position, speed and acceleration).

When a stator coil 150 is energized, the nearby permanent magnets 160 coupled, in some embodiments, to rotor 110, may be caused to follow a substantially circular path, following interaction of the magnetic field associated with a given permanent magnet 160 with the induced electromagnetic field associated with a stator coil 150 having an electrical current flowing therethrough. The magnet 160 may either be pulled-in towards the air-core 152 of the energized stator coil 150, or pushed-out from the same, depending on current direction and the polarity of the switch associated with the given coil 150, which determines the direction of flow of the current in the wire windings, and on the orientation of the magnets 160 (N-S or S-N). In turn, the status of a switch may in some embodiments be determined at each time by the controller, based on the angular position of the rotor 110 detected by one or more sensors (not shown). A continuous smooth rotation of the rotor 110 in either rotational direction may be obtained with the proper simultaneous operating sequence of the overall system of switches.

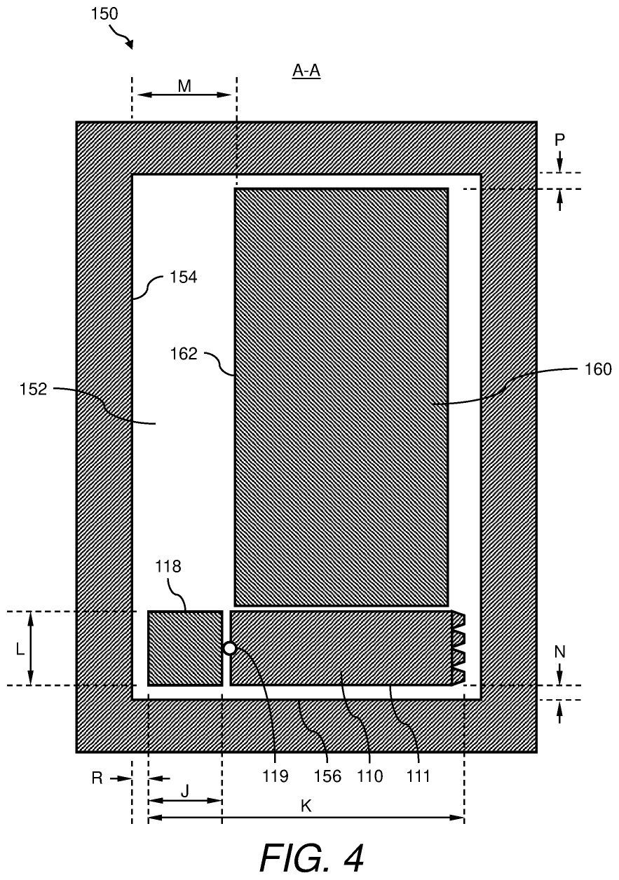

Referring now to FIG. 4, an exemplary cross-sectional view identified as A-A in FIG. 3 of a stator coil 150 is presented. As illustrated, in some embodiments, core 152 of stator 150 may be sized such that annular bearing member 118 (with inner race 119), rotor 110, and permanent magnet 160 may pass therethrough with minimized clearances on all sides. For example, stator coil 150 may be sized such that a clearance R between annular bearing member 118 and an inner wall 154 of core 152 is minimized In some embodiments, the radial clearance R is preferably no more than 0.5 mm, though greater clearances are possible. In some embodiments, the radial clearance R may range from approximately 0.35-0.48 mm. In some embodiments, the radial width of annular bearing member 118 (indicated in FIG. 4 as dimension J) preferably constitutes a range of no more than between about 25% to about 35% of rotor 110 and annular bearing member 118 combined (i.e., radial dimension K), and in one embodiment is about 30%. In some embodiments, the radial clearance M between inner wall 154 of core 152 and a radially inner surface 162 of permanent magnet 160 is preferably no more than 2 mm so as to maximize the generated torque by increasing the interaction between the magnetic field associated with permanent magnet 160 and the induced electromagnetic field associated with stator coil 150 (though greater clearances are possible).

In like manner, support posts 146 (FIG. 2) supporting annular bearing member 118 may be configured such that the annular bearing member 118 and the rotor 110 are set as close to a lowermost surface 156 of core 152 as possible (while, depending on intended operation, allowing for sufficient clearances), thereby minimizing a dimension N in FIG. 4. In some embodiments, the longitudinal dimension N is no more than 0.5 mm. For example, the longitudinal dimension N may range between about 0.35 mm to about 0.48 mm. In some embodiments, the longitudinal clearance P may also be no more than 0.5 mm. For example, the longitudinal clearance P may range between about 0.35 mm and about 0.48 mm. Again, however, greater (and lesser) clearances for N and P are possible.

It will be further appreciated that other configurations are possible. For example, magnet 160 may have a shape that extends over, but is not attached to, bearing member 118 such that clearance M is minimized beyond that shown in FIG. 4.

In some embodiments, rotor 110 and annular bearing member 118 may be sized such that longitudinal dimension L is minimized while still adequately supporting rotation of rotor 110 and the transfer of rotation energy from rotor 110 to gear pair 130. In some embodiments, magnet 160 may be integrated into rotor 110 such that magnet 160 may extend to a lowermost portion 111 of rotor 110.

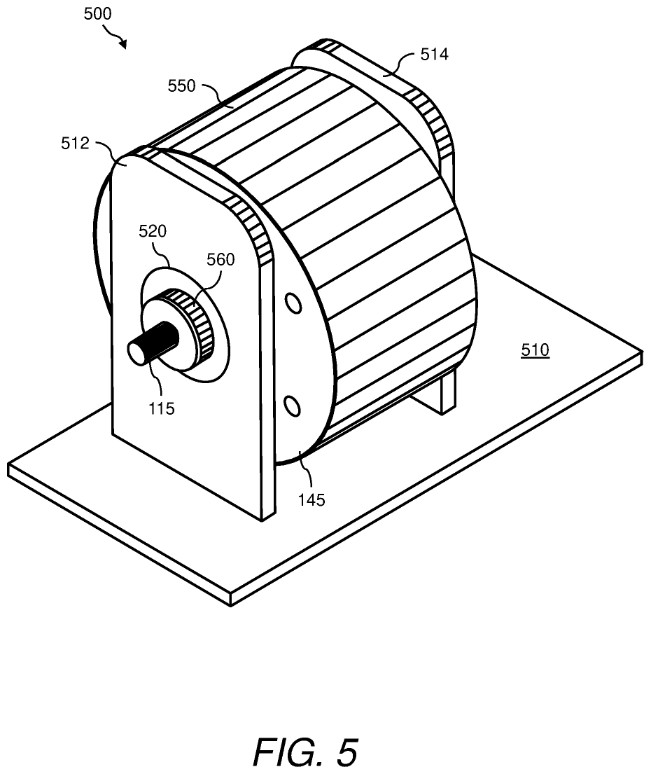

Referring now to FIG. 5, an exemplary housing 500 is presented in which motor 100 may be housed. Housing 500 may include, in some embodiments, a base plate 510 and mounting plates 512 and 514. In some embodiments, output shaft 115 may protrude substantially longitudinally from housing 500 at one or both ends of housing 500. In some embodiments, housing 500 may include one or more bearings 520 on one or both ends of the housing 500 to facilitate rotation of output shaft 115.

Housing 500 may also include an outer casing 550 to enclose the motor 100. In some embodiments, casing 550 extends circumferentially about motor 100 and may be coupled to end plates on either end of motor 100 (e.g., end plate 145). Central plate 140 (FIG. 2) may also be coupled in appropriate fashion to casing 550. In some embodiments, casing 500 with motor 100 therein may be configured to be mounted between mounting plates 512 and 514 such that casing 500 can rotate about the axis of output shaft 115. In such embodiments, one or more bearings 520 and/or axles 560 may be employed. In such manner, where the rotating casing 550 is rotatable about the output shaft 115, there may be an increase in magnitude of power transferred from the motor. For example, in some embodiments, the output shaft may be fixed and the casing 550 free to rotate in response to the rotation of the motor 100. In another example, the output shaft 115 coupled to rotor 110 may be free to rotate along with the stator coils 150 and casing 550, thereby generating torque but with reduced relative rotational velocity between the magnets 160 and stator coils 150. Such reduced relative velocity may advantageously reduce back-EMF induced in the motor 100 that would otherwise reduce the effective torque. In some embodiments, multiple motors 100 may be employed in, for example, a vehicle, to generate high-speed torque at reduced relative rotational velocity between the magnets 160 and coils 150, thereby increasing torque at high-speeds relative to other motors.

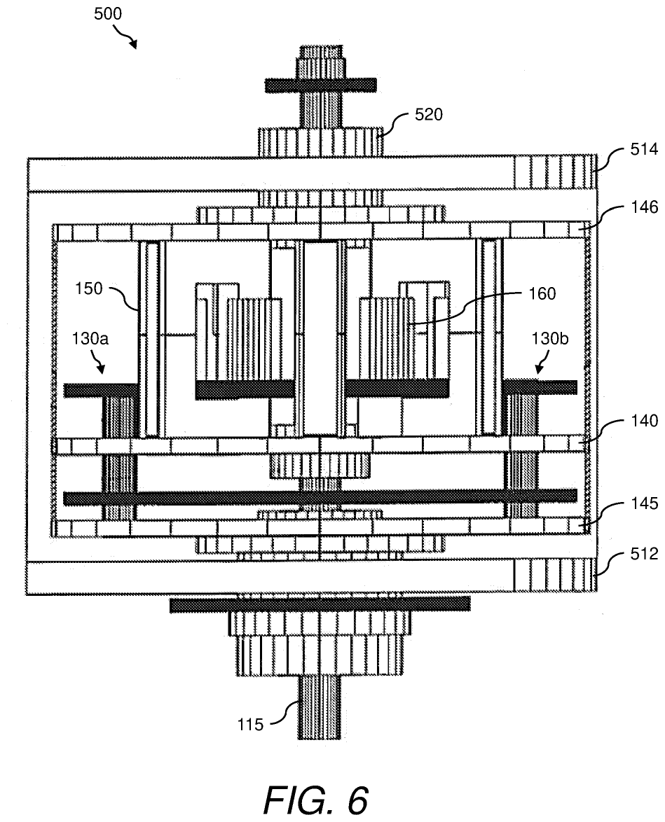

Referring now to FIG. 6, a cross-sectional view of an exemplary embodiment of motor 100 mounted inside housing 500 is presented. In some embodiments, coils 150 may be mounted to central plate 140 and a top-end plate 146 opposite end plate 145. The elements described above for enabling, in some embodiments, rotation of the housing 500 about output shaft 115 (e.g. axles 560 and/or bearings 520) are also depicted.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

The following clauses describe further preferred aspects of the present invention:

i) A rotationally balanced electric motor, comprising:
a. a magnet-equipped and externally geared annular rotor;
b. an output shaft having a longitudinal axis disposed at a center of the rotor;
c. a plurality of circumferentially spaced air-core stator coils encircling the rotor;
d. an externally geared disc disposed parallel to the rotor and coupled to, and concentric with, the output shaft; and
e. a plurality of symmetrically positioned common-shaft gear pairs configured to transmit motion from the rotor to the disc and to thereby transmit power to the output shaft without interfering with any of said plurality of air-core stator coils.
   ii) The electric motor according to clause i, further comprising a casing.
   iii) The electric motor according to clause ii, wherein the common shaft of each of the plurality of gear pairs is rotatably mounted within two parallel surfaces of the casing.
   iv) The electric motor according to clause ii, wherein the casing is hollow, and the rotor, the disc, the plurality of air-core stator coils, and the plurality of gear pairs are housed within an interior of the casing.
   v) The electric motor according to any one of the preceding clauses, further comprising an annular bearing member for radially supporting the rotor and a plurality of circumferentially spaced support posts extending in a direction parallel to the longitudinal axis of the output shaft and coupled to said bearing member.
   vi) The electric motor according to clause v, wherein the bearing member is a rotor-integrated bearing member comprising a plurality of rolling elements retained between a rotor portion constituting an outer race of the rotor-integrated bearing member and an inner stator race portion, wherein the rotor portion is provided with external gearing that intermeshes with a first gear of the plurality of common-shaft gear pairs.
   vii) The electric motor according to clause vi, wherein a second gear of the plurality of common-shaft gear pairs intermeshes with the external gearing of the disc to transmit power to the output shaft.
   viii) The electric motor according to clause vii, wherein a gear ratio between the gearing of the rotor and of the first gear is equal to a gear ratio between the gearing of the disc and of the second gear to ensure that the output shaft will rotate at substantially a same rate as the rotor portion.
   ix) The electric motor according to any one of clauses vi to viii, wherein an entire radial length of the rotor-integrated bearing member is received, for a given sector thereof, within an air core of a given stator coil.
   x) The electric motor according to any one of clauses vi to ix, wherein each of the plurality of air-core stator coils has a rectangular coil body that surrounds a rectangular air-core and is oriented radially with respect to the rotor portion.
   xi) The electric motor according to any one of the preceding clauses, wherein each of the common-shaft gear pairs is positioned within a clearance between a radially outward-most portion of two adjacent air-core stator coils, and without interfering with the stator coils.
   xii) The electric motor according to any one of clauses v to xi, wherein each of the support posts has a triangular configuration and is positioned within a clearance between a radially innermost portion of two adjacent air-core stator coils, and without interfering with the stator coils.
   xiii) The electric motor according to any one of clauses v to xii, wherein the plurality of support posts are also connected to one of the two parallel surfaces of the casing.
   xiv) The electric motor according to any one of clauses ii to xiii, wherein the casing is stationary.
   xv) A rotationally balanced electric motor with air-core stator coils, comprising:
a. a casing;
b. a magnet-equipped and externally geared annular rotor;
c. an output shaft with a longitudinal axis positioned at a center of said rotor;
d. a plurality of circumferentially spaced air-core stator coils connected to said casing and encircling said rotor;
e. an externally geared disc parallel to said rotor and connected to, and concentric with, said output shaft; and
f. a plurality of symmetrically positioned common-shaft gear pairs configured to transmit motion from said rotor to said disc and to thereby transmit power to said output shaft without interfering with any of said plurality of air-core stator coils.
   xvi) The electric motor according to any one of the preceding clauses, further comprising a plurality of switches for controlling a current and current polarity in the air-core stator coils, and a controller for controlling the switches, wherein the controller selectively operates the switches to generate smooth rotation of the rotor.
   xvii) The electric motor according to clause xv, further comprising one or more sensors for determining positions of the magnets relative to the air-core stator coils, wherein the sensor data is input to the controller.

1. A rotationally balanced electric motor, comprising:
a) a magnet-equipped and externally geared annular rotor;
b) an output shaft having a longitudinal axis disposed at a center of the rotor;
c) a plurality of circumferentially spaced air-core stator coils encircling the rotor;
d) an externally geared disc disposed parallel to the rotor and coupled to, and concentric with, the output shaft; and
e) a plurality of symmetrically positioned common-shaft gear pairs configured to transmit motion from the rotor to the disc and to thereby transmit power to the output shaft without interfering with any of said plurality of air-core stator coils.

2. The electric motor according to claim 1, further comprising a casing.

3. The electric motor according to claim 2, wherein the common shaft of each of the plurality of gear pairs is rotatably mounted within two parallel surfaces of the casing.

4. The electric motor according to claim 2, wherein the casing is hollow, and the rotor, the disc, the plurality of air-core stator coils, and the plurality of gear pairs are housed within an interior of the casing.

5. The electric motor according to claim 1, further comprising an annular bearing member for radially supporting the rotor and a plurality of circumferentially spaced support posts extending in a direction parallel to the longitudinal axis of the output shaft and coupled to said bearing member.

6. The electric motor according to claim 5, wherein the bearing member is a rotor-integrated bearing member comprising a plurality of rolling elements retained between a rotor portion constituting an outer race of the rotor-integrated bearing member and an inner stator race portion, wherein the rotor portion is provided with external gearing that intermeshes with a first gear of the plurality of common-shaft gear pairs.

7. The electric motor according to claim 6, wherein a second gear of the plurality of common-shaft gear pairs intermeshes with the external gearing of the disc to transmit power to the output shaft.

8. The electric motor according to claim 7, wherein a gear ratio between the gearing of the rotor and of the first gear is equal to a gear ratio between the gearing of the disc and of the second gear to ensure that the output shaft will rotate at substantially a same rate as the rotor portion.

9. The electric motor according to claim 6, wherein an entire radial length of the rotor-integrated bearing member is received, for a given sector thereof, within an air core of a given stator coil.

10. The electric motor according to claim 6, wherein each of the plurality of air-core stator coils has a rectangular coil body that surrounds a rectangular air-core and is oriented radially with respect to the rotor portion.

11. The electric motor claim 1, wherein each of the common-shaft gear pairs is positioned within a clearance between a radially outward-most portion of two adjacent air-core stator coils, and without interfering with the stator coils.

12. The electric motor claim 1, wherein each of the support posts has a triangular configuration and is positioned within a clearance between a radially innermost portion of two adjacent air-core stator coils, and without interfering with the stator coils.

13. The electric motor claim 1, wherein the plurality of support posts are also connected to one of the two parallel surfaces of the casing.

14. The electric motor claim 1, wherein the casing is stationary.

15. A rotationally balanced electric motor with air-core stator coils, comprising:
a) a casing;
b) a magnet-equipped and externally geared annular rotor;
c) an output shaft with a longitudinal axis positioned at a center of said rotor;
d) a plurality of circumferentially spaced air-core stator coils connected to said casing and encircling said rotor;
e) an externally geared disc parallel to said rotor and connected to, and concentric with, said output shaft; and
f) a plurality of symmetrically positioned common-shaft gear pairs configured to transmit motion from said rotor to said disc and to thereby transmit power to said output shaft without interfering with any of said plurality of air-core stator coils.

16. The electric motor according to claim 15, further comprising a plurality of switches for controlling a current and current polarity in the air-core stator coils, and a controller for controlling the switches, wherein the controller selectively operates the switches to generate smooth rotation of the rotor.

17. The electric motor according to claim 15, further comprising one or more sensors for determining positions of the magnets relative to the air-core stator coils, wherein the sensor data is input to the controller.
